(19) United States
(12) Patent Application Publication
(10) Pub. No.: US 2009/0010812 A1
(43) Pub. Date: Jan. 8, 2009

(54) APPARATUS AND MEANS FOR CONTROLLING TEMPERATURE DURING LIQUID PURIFICATION

(75) Inventor: Robert D Fite, Boyne Falls, MI (US)

Correspondence Address: JOHN K. MCCORMICK, 6781 GLACIER DRIVE, WEST BEND, WI, 53090, US

(73) Assignee: Quench Environmental Products, LLC, Petoskey, MI (US)

(21) Appl. No.: 12/145,278

(22) Filed: Jun. 24, 2008

Related U.S. Application Data
(63) Continuation-in-part of application No. 11/774,560, filed on Jul. 7, 2007, now abandoned.
Application No. 11/774,560 is a division of application No. 10/905,039, filed on Dec. 13, 2004, now Pat. No. 7,255,789.

(51) Int. Cl. G05D 25/00; B01J 19/12

(52) U.S. Cl. 422/106; 422/186.3; 422/186

(57) ABSTRACT

An apparatus and means for separating an ultraviolet light source from a liquid and for controlling the temperature of the ultraviolet light source to its optimal temperature range for modifying contaminants in a liquid.

This application is a continuation-in-part of divisional application Ser. No. 11/774,560 filed on Jul. 7, 2007 which claims the benefit of and is a divisional application of Ser. No. 10/9805039, filed on Dec. 13, 2004, now U.S. Pat. No. 7,255,789 filed in the name of the same inventor.

### BACKGROUND OF THE INVENTION

Presently, the quality of the global pure drinking water supply is decreasing at a faster rate than the population is expanding. The United Nations International children's Educational Foundation (UNICEF) estimates that 20,000 to 30,000 children die every day from waterborne diseases such as typhoid, malaria, e-coli, cholera and many other contaminants. These contaminants can also include such things as salts, halogens, organic solvents, pesticides, fertilizers, industrial chemicals, bacteria, protozoa, fungi and other foreign matters.

The extensive use of fertilizers and pesticides by farmers, runoffs from major animal husbandry sites, contamination spills by industries, the dumping of raw sewage into our lakes and streams and the significant number of landfill sites have caused many contaminants to percolate down through the soil and into the underlying water tables throughout the world. The result is that today many more wells and springs are now testing positive for a wide array of toxins and contaminants harmful to human, animal and plant health.

In many areas of the world, and in the United States of America, public water supply systems are monitored for diseases and toxins on a regular basis to assure the public that the water is safe to drink. However, cases are still reported in the U.S. of contaminated water supply systems. Furthermore the majority of the water piping and distribution systems in the U.S., and internationally, are many decades old and as the water passes from a main purification site to an end user, the water can pickup additional contaminants and toxins from the aging water distribution systems.

There have been a variety of attempts to provide purified water at a user or business' point of entry and/or point of use site. One such device is known as the Britta. It is a single stage filter utilizing the laws of gravity and a carbon block held in a container. Water is poured into a top holding container and gravity slowly draws the water through the carbon block to a lower container for consumption. Carbon does reduce some toxic chemicals and gases from water however it does not purify the water. This device is also greatly limited by the capacity of water that it can produce in a 24-hour period. It most certainly would not produce enough filtered water to supply a family of four with enough drinking and cooking water for an entire day.

There are other products available that provide two stage filtering devices consisting of a carbon block filtration and a paper filter surrounding or in line with the carbon block. However, these systems do not address the issue of microorganisms in the water, which can bypass the filtration systems.

Yet another product available to consumers is a device called the Pur water filter. This system utilizes a small and low wattage ultraviolet (UV) lamp and a carbon block filter. The UV light is known to kill microorganisms in the air and in water. Unfortunately, the UV lamp deteriorates over time to the point that it cannot produce the necessary wavelength to kill microorganisms in the water. Furthermore, the system does not provide a means to know when the UV lamp has deteriorated. As such, the end user may think that the device is adequately killing microorganisms when in fact the UV lamp has become useless as a biocide. The use of a laser for producing UV light for treating water has also been described by Goudy in U.S. Pat. No. 4,661,264

Another additional means of purifying water has been the use of what is known as KDF 85 and/or KDF 55 as a biocide and is described by Heskett in U.S. Pat. No. 5,951,869. This process utilizes a compound that is basically copper and zinc that creates and ion exchange and chelating (clumping together) producing properties in the water. This material is primarily used in large municipal water treating systems however there have been some attempts to have the KDF 85 or KDF 55 material impregnated onto a paper filter for point of use water treatment systems with limited success.

While all of the above presented means provide some degree for improving the water supply, none of them fully purify the water in an economical and efficient manner. As such, a technical need still exists to purify water, air or other fluids quickly, efficiently, over a long-term use and do so economically.

### BRIEF DESCRIPTION OF THE DRAWINGS

The invention will be better understood by reading the detailed description of the preferred embodiments of the invention along with a review of the drawings, in which:

FIG. 1 is an overall view of the various components of the invention;

FIG. 2 is a planer view of the first and second photolytic light chambers used in the embodiment of FIG. 1;

FIG. 3 is a perspective view of an alternative assembled photolytic light chamber; and

FIG. 4 is an exploded view of the alternative photolytic light chamber.

### DETAILED DESCRIPTION OF THE INVENTION

Reference will now be made in detail to the description of the invention as illustrated in the drawings. Although the preferred embodiments of the invention will be described in connection with these drawings, there is no intent to limit the invention to the embodiment or embodiments disclosed therein. On the contrary, the intent is to include all alternatives, modifications and equivalents included within the spirit and scope of the invention as defined by the appended claims.

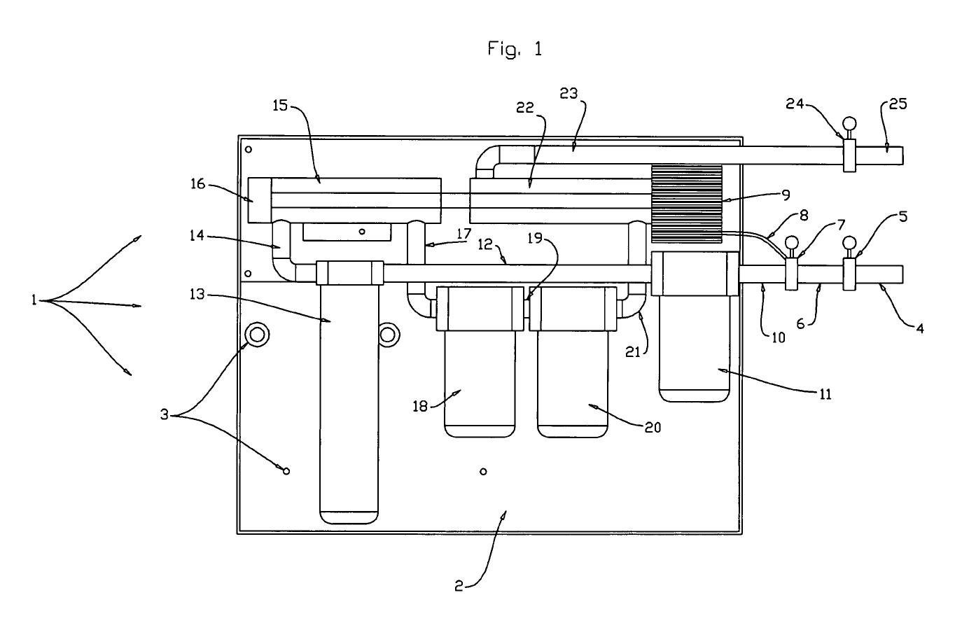

Furthermore, the order of the itemized steps in FIG. 1 are not meant to limit the scope of the invention to the specific itemized order of those steps, but rather to include those steps in any relevant order including any alternatives, modifications and equivalents included within the spirit and scope of the invention as defined by the appended claims.

To aid in the understanding of the invention, examples of some of the specific itemized steps are provided for clarification purposes only. In particular, some of the examples use water for the liquid being purified, however, these examples are not meant to limit the invention to only water, but rather to include any alternative, modification and equivalents included within the spirit and scope of the invention as defined by the appended claims.

The present invention provides a method and apparatus for treating water or other liquid to assure that the water or liquid is of a high degree of purity. The origin of the water or liquid can be from any source such as municipal water supply systems, independent well systems, tanker truck or rail car, a lake, a river, desalinized sea water, collected rail water or other like source.

FIG. 1 depicts an overall view of the liquid treating apparatus 1 without the cover for the apparatus. The liquid treating apparatus 1 contains a base 2 to which elements of the liquid treating apparatus are connected. The base 2 is constructed with a plurality of mounting holes 3 such that the liquid treating apparatus can be mounted to a wall (not shown) or a frame (not shown). Other equally effective mounting systems are well known in the art.

The water or other liquid (not shown) flows from a pressurized source (not shown) through the inlet pipe 4 through a pressure regulator 5 through a first transfer pipe 6 and then through a flow indicator 7. The pressure regulator 5 assures that the liquid is maintained at or below a predetermined pressure setting for optimal operating efficiency of the liquid treating apparatus 1. The flow meter 7 is connected 8 to the laser light source generator 9 such that the laser light source generator 9 only generates a laser light (not shown) in the ultraviolet range when the flow indicator 7 indicates that liquid is flowing through the liquid treating apparatus 1. As the liquid exits the flow indicator the liquid travels through a second transfer pipe 10 to the first stage of the liquid treatment apparatus 1.

The first stage of the liquid treatment apparatus 1 is the primary collective filtration unit 11. The primary collective filtration unit 11 contains a 5.0 micron filter whose primary purpose is to prevent any chemical, particulate matter or other media 5.0 microns or larger from traveling any further than this stage in the liquid treating apparatus 1.

The liquid then exits the primary collective filtration unit 11 and travels through a third transfer pipe 12 to the second stage of the liquid treatment apparatus 1. The second stage of the liquid treatment apparatus 1 is a molecular reaction unit 13, called the Hydro-Media Reaction Chamber that functions as an effective biocide.

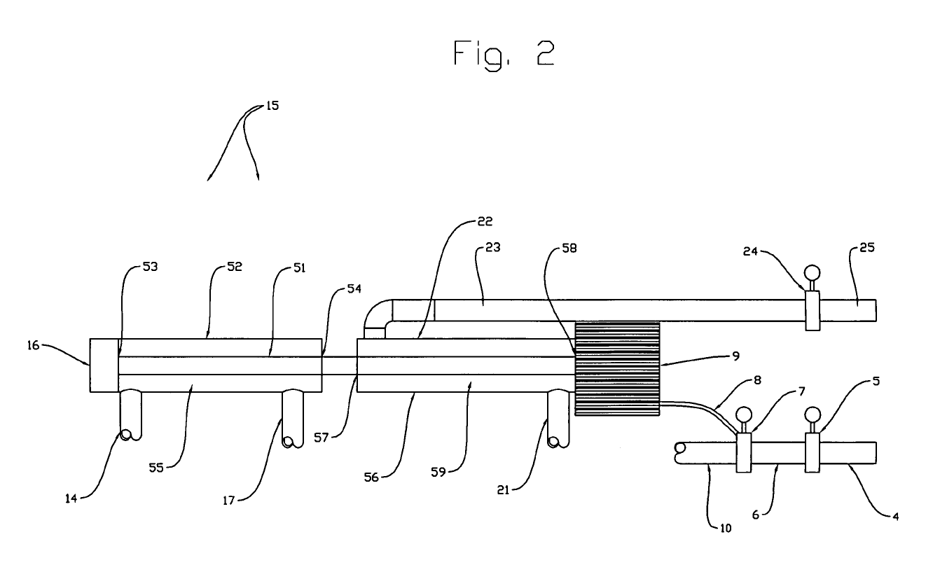

The liquid then exits the molecular reaction unit 13 and flows through a fourth transfer pipe 14 to the third stage of the liquid treatment apparatus 1. The third stage of liquid treatment apparatus is a first photolytic laser chamber 15 in which the liquid is subjected to ultraviolet light in the 100 to 300 nanometer range produced by a laser light source generator 9 and received by a laser light receiver 16. This process acts as a biocide by altering the contaminants so that they can be filtered out later and removes volatile organic compounds. The ultraviolet light destroys organic compounds by breaking the covalent bonds in the chemical thereby forming free radicals which react with water and break down into harmless substances. Details of the first and second photolytic light chambers 15 and 22 are shown later in FIG. 2.

The liquid then exits the first photolytic laser chamber 15 through a fifth transfer pipe 17 and enters a secondary collective filtration unit 18. The secondary collective filtration unit 18 utilizes a 0.5 micron filter which traps or collects all of the destroyed microorganisms that were affected by the first photolytic laser chamber 15 and any particulate matter or other media that is 0.5 microns in size or larger.

The liquid then exits the secondary collective filtration unit 18 and travels through a sixth transfer pipe 19 to a carbon filtration unit 20. The carbon filtration unit 20 utilizes a pharmaceutical grade granular activated carbon filter. This unit removes odors, chlorine, benzenes and other aromatic ring structures, pesticides and many other volatile organic hydrocarbons that may be found in various combinations in water and/or other liquids. The granular configuration of the activated carbon provides an effective method for maintaining a desired liquid flow rate with maximum beneficial results in eliminating the aforementioned odors and compounds.

The liquid then exits the carbon filtration unit 20 through a seventh transfer pipe 21 and enters a second photolytic laser chamber 22. The second photolytic laser chamber 22 also operates in the 100 to 300 nanometer range. This second photolytic laser chamber 22 is the final stage in the liquid treatment apparatus 1 and assures that the liquid and/or water leaving the unit is free from microorganisms by subjecting the liquid or water to a second ultraviolet light process identical to the first photolytic laser chamber 15. This provides additional protection to overcome any effects of colonization or of filtration failure. The water or other liquid then exits the unit through an eighth transfer pipe 23.

The eighth transfer pipe 23 is then connected to a pressure gage 24 which is in turn connected to the out going liquid supply line 25. The pressure gage 24 is color coded in red, yellow and green zones. When the pressure gage 24 indicates that the liquid pressure in the liquid treatment apparatus 1 is in the green zone, the filters do not have to be replaced. When the pressure gage 24 indicates that the liquid pressure is in the yellow zone, it is time to prepare for changing the filters or to change the filters. When the pressure gage 24 indicates that the liquid pressure is in the red zone, the filters should be replaced.

FIG. 2 depicts the preferred embodiment of the design of the first and second photolytic light chambers 15 and 22. On one end of the second photolytic light chamber 22 is the laser light source generator 9 and on one end of the first photolytic light chamber 15 is the laser light receiver 16. In between the generator 9 and the receiver 16 is a continuous hollow quartz tube 51 through which the laser light (not shown) travels in operation. A first tube 52 surrounds a first portion of the quartz tube 51 and is sealed around the quartz tube at both ends of the tube 53 and 54. There is a space 55 through which the liquid will pass around the quartz tube 51 when the unit is in operation. This creates the first photolytic light chamber 15. A second tube 56 surrounds a second portion of the quartz tube 51 and is sealed 57 and 58 at both ends of the tube 56 around the quartz tube 51. There is a space 59 between the quartz tube 51 and the tube 56 through which the liquid will pass around the quartz tube 51. The spaces 55 and 59 are the chambers through which the liquid passes and becomes exposed to the ultraviolet laser light (not shown) which is generated by the laser light generator 9 and received by the laser light receiver 16.

In the first and second photolytic light chambers 15 and 22, as the liquid flows under pressure as indicated by the flow meter 7 attached to the first transfer pipe 6, the flow meter 6 sends a signal through the connection 8 to the laser light generator 9 which activates the laser light. A laser light, in the 100 to 300 nanometer range, travels through the inside of the quartz tube 51 to the laser light receiver 16. As the liquid flows through the spaces 55 and 59 in the photolytic light chambers 15 and 22, the liquid is exposed to the laser light in the 100 to 300 nanometer range. This range of light is known to act as an effective biocide and to reduce metallic salts by altering contaminants into harmless components which can be filtered out later. The light also destroys organic compounds by forming free radicals from the compounds which then react with water to break down into harmless substances.

When the liquid or water stops flowing as indicated by the flow meter 7, the laser light generator 9 shuts off the laser light source so that the laser light source 9 and the power consumption is only used when there is liquid flowing through the system. In addition, the laser light generator 9 can be set to operate in a specific range such as 185 or 254 nanometers, or is can be set to oscillate or switch between two or more nanometer ranges for optimum performance. Some of the more obvious advantages to this design is the use of a single source of light for a creating a multitude of exposures and the ability to target a range of ultraviolet light on the liquid to be treated as opposed to a single wavelength. In addition, an ultraviolet light produced by a laser light source will not degenerate over time as does an ultraviolet lamp thus providing a long and economical useful life of the unit.

In an alternative embodiment to the photolytic light chambers 15 and 22, there is only a short piece of quartz rod 51 or other lens like material that connects the end of the first photolytic light chamber 15 to the end of the second photolytic light chamber 22 and allows for the passing of the laser light in the 100 to 300 nanometer range, without inhibiting the laser light spectrum, from the first photolytic light chamber 15 to the second photolytic light chamber 22. Usage of a lens or other device attached between the two photolytic chambers allows transfer of the laser beam through both chambers simultaneously and also denies crossover contamination of the liquid. Thus, instead of the liquid being exposed to the ultraviolet light radiating outward from the quartz tube 51, the liquid is exposed directly to the ultraviolet laser light inside of the photolytic light chambers 15 and 22. In addition, the lens or a thin piece of the rod 51 could be placed in front of the laser light generator 9 and in front of the laser light receiver 16 which would prevent any direct conductive connection between the liquid and the laser light generator 9 and/or the laser light receiver 16. In another alternate embodiment, the inside of the first and second tubes 52 and 56 can be modified for the desired reflective capabilities allowing for greater exposure of the liquid to the desired ultraviolet light range thereby achieving a more through biocide coverage of the liquid. In a further embodiment, the first photolytic light chamber 15 can be placed in a horizontal position and the second photolytic light chamber 22 placed in a vertical position with a reflective material used to bend the laser light from a horizontal position to a vertical position.

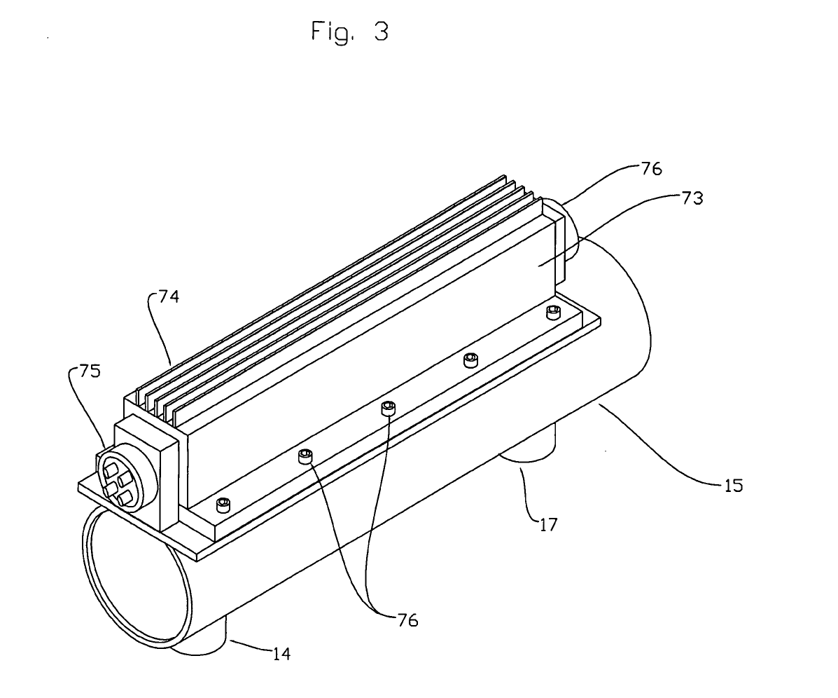

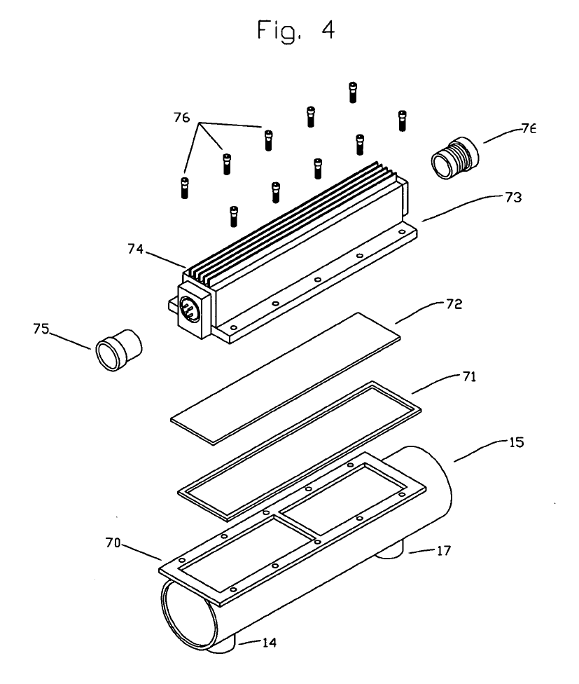

In a further embodiment to the photolytic light chamber 15 as depicted in FIGS. 3 and 4, the top portion of the photolytic light chamber 15 is removed or cut away 70. On top of this opening is placed a sealing gasket 71 and a flat lens 72 made of the same material as the prior rod or tube. On top of the lens 72 is placed an ultraviolet light bulb housing 73. The top of the light bulb housing 73 incorporates heat sink cooling fins 74. There are access caps 75 and 76 at both ends of the light bulb housing 73. One end cap 75 allows for the ultraviolet bulb socket ends. These end caps 75 and 76 allow for the replacement of the ultraviolet light bulb without draining the system of liquid as the bulb is effectively separated from the liquid while the ultraviolet light is allowed to penetrate the liquid through the lens 72.

One end of the photolytic light chamber 15 has a removable end cap (not shown) which allows for the periodic cleaning of the lens 72 if contamination of the lens 72 should occur. The photolytic light chamber 15 also has liquid input 14 and liquid output 17 openings strategically placed on the bottom of the photolytic light chamber directly facing the flat lens 72. This positioning, combined with the inner shape of the photolytic light chamber 15 that is partially rounded and partially flat, causes liquid flowing through the photolytic light chamber 15 to flow in a turbulent manner. The turbulent flow of the liquid aids in keeping the liquid side of the flat lens 72 free from contamination. As is known in the art, contamination of any lens between the ultraviolet light source and the liquid significantly compromises the effectiveness of the ultraviolet light's interaction with contaminants in the liquid as the contamination reduces or eliminates the ultraviolet wavelength and strength.

Additionally, an ultraviolet light bulb's effectiveness during the purification process is directly related to the temperature in which the ultraviolet light is operating. Maximum effectiveness for ultraviolet light transmission is in the range of 94 degrees Fahrenheit to 114 degrees Fahrenheit. The optimal temperature for ultraviolet light to act as a biocide is in the 103 to 105 degree Fahrenheit range. A level of ultraviolet transmission outside of the 94 to 114 degree Fahrenheit temperature range substantially reduces the effective dosage of ultraviolet light emissions needed for the destruction of microorganisms and metallic salts. In addition, the separation of the light bulb from the liquid by the flat lens 72 prevents condensate from accumulating in the bulb which is known to cause premature shorting of the bulb.

As depicted in FIGS. 3 and 4, a preferred embodiment of the bulb housing includes heat sinks 74 on the top side of the bulb housing 73 to dissipate excess heat thereby assuring that the optimum heat range of 94 degrees Fahrenheit to 114 degrees fahrenheit is maintained. The screws 76 are utilized to assemble the bulb housing 73, the flat lens 72 and gasket to the photolytic light chamber 15.

I claim:

1. A means for maintaining the temperature of an ultraviolet light source used for treating a liquid comprising:
a. a means for supplying said liquid under pressure to a light chamber;
b. a means for generating light in the 100 to 300 nanometer range;
c. a means for separating said liquid from said light source in a manner that allows said light to pass through said separating means without diminishing said light wavelength spectrum;
d. a means for exposing said liquid in said chamber to said light from said light generator;
e. a means for exiting said light treated liquid from said chamber; and
f. a means for maintaining the temperature of said light generating means between 94 degrees Fahrenheit and 114 degrees Fahrenheit.

2. The means for maintaining the temperature of an ultraviolet light source as defined by claim 1, wherein said means for exposing said liquid to said light further comprises a means for controlling said light to a specific pre-set wavelength in the 100 to 300 nanometer range.

3. The means for maintaining the temperature of an ultraviolet light source as defined by claim 1, wherein said means for exposing said liquid to said light further comprises a means for controlling said light to a specific wavelength in the 100 to 300 nanometer range that can be set by a user.

4. The means for maintaining the temperature of an ultraviolet light source as defined by claim 1, wherein said means further comprises a means for controlling said light to oscillating wavelength spectrums of said light within different 100 to 300 nanometer ranges at pre-selected wavelength spectrums and oscillation speed.

5. The means for maintaining the temperature of an ultraviolet light source as defined by claim 1, wherein said means further comprises a means for controlling said light to oscillating wavelength spectrums of said light within different 100 to 300 nanometer ranges at user selected wavelength spectrums and oscillation speed.

6. The means for maintaining the temperature of an ultraviolet light source as defined in any one of claims 1 through 5, wherein said means further comprises a means for activating said light generator to expose said liquid in said chamber only when said liquid is flowing through said chamber.

7. The means for maintaining the temperature of an ultraviolet light source as defined in any one of claims 1 through 5, wherein said means of generating light is a laser light generator.

8. The means for maintaining the temperature of an ultraviolet light source as defined in any one of claims 1 through 5, wherein the inner side of the said light chamber further comprises a means to refract said light back through said liquid.

9. An apparatus for maintaining the temperature of an ultraviolet light source used for treating liquid comprising:
a. a liquid supply line for supplying said liquid under pressure into a light chamber;
b. a light generator for generating light in the 100 to 300 nanometer range, said light generator enclosed in a light generator housing;
c. a lens for separating said liquid from said light source in a manner that allows said light to pass through said lens without diminishing said light wavelength spectrum and into said light chamber;
d. heat sink fins attached to said light generating housing; and
e. a liquid exit line for exiting the light treated liquid from said chamber.

10. The apparatus for treating liquid as defined by claim 9, wherein said apparatus further comprises controls for setting said light to a specific pre-set wavelength in the 100 to 300 nanometer range.

11. The apparatus for treating liquid as defined by claim 9, wherein said apparatus further comprises secondary controls for setting said light to a specific wavelength in the 100 to 300 nanometer range that can set by a user.

12. The apparatus for treating liquid as defined by claim 9, wherein said apparatus further comprises controls for causing said light to oscillate the wavelength spectrums of said light within different 100 to 300 nanometer ranges at pre-selected wavelength spectrums and oscillation speed.

13. The apparatus for treating liquid as defined by claim 9, wherein said apparatus further comprises controls for causing said light to oscillate the wavelength spectrums of said light within different 100 to 300 nanometer ranges at user selected wavelength spectrums and oscillation speed.

14. The apparatus for treating liquid as defined in any one of claims 9 through 13, wherein said apparatus further comprises controls for activating said light generator to expose said liquid in said chamber to said light only when said liquid is flowing through said chamber.

15. The apparatus for treating liquid as defined in any one of claims 9 through 13, wherein the inner side of said chamber is polished to refract said light back through said liquid
